(19) United States
(12) Patent Application Publication
(10) Pub. No.: US 2017/0274300 A1
(43) Pub. Date: Sep. 28, 2017

(54) Dirt Separator

(71) Applicant: IMI Hydronic Engineering International SA, Eysins (CH)

(72) Inventors: Markus Bobbert, Riehen (CH); Gian Schläpfer, Liestal (CH); Alain Scherrer, Muttenz (CH); Valentin Huber, Basel (CH)

(21) Appl. No.: 15/464,697

(22) Filed: Mar. 21, 2017

(30) Foreign Application Priority Data
Mar. 22, 2016 (EP) 16161546.3

(51) Int. Cl. B01D 21/26; B01D 21/00

(52) U.S. Cl. CPC B01D 21/26; B01D 21/0009; B01D 21/0012; B01D 21/0024; B01D 21/0039

(57) ABSTRACT

A dirt separator including a vessel having a separation container having a lateral container wall, a container bottom, and a container axis, which container has an inlet and an outlet as well as an interior, and having a particle separation chamber, which is disposed at the outlet of the separation container and stands in a fluid connection with the separation container, an inlet for supply of liquid into the vessel, and an outlet for discharge of the liquid out of the vessel. The dirt separator is configured in such a manner that liquid introduced into the separation container flows downward along the container wall in a cyclone-like movement, and then flows upward to the particle separation chamber within the liquid that flows downward in cyclone-like manner, and the dirt separator includes at least one particle separator, which is disposed in the particle separation chamber.

### CROSS-REFERENCE TO RELATED APPLICATION

This application claims priority to European Patent Application No. 16161546.3 filed Mar. 22, 2016, the disclosure of which is hereby incorporated in its entirety by reference.

### BACKGROUND OF THE INVENTION

Field of the Invention

The present invention relates to a dirt separator.

Description of Related Art

Dirt separators that function according to the cyclone principle, among other things, are used for separation of solid particles entrained in a stream of liquid. A dirt separator of this type is described, for example, in the international patent application WO 2009/122127 A1. This known dirt separator comprises a pot-like separation container having an inlet disposed in the upper container region for supply of liquid into the separation container and an outlet, also disposed in the upper container region, for discharge of the liquid from the separation container. The dirt separator may be installed in a line that conducts liquid, for example of a hot-water heating system, by way of the inlet and the outlet. A tube that is open toward the bottom is coaxially disposed in the interior of the separation container. The outlet is connected with the interior of the pipe so as to communicate with it; the inlet opens into the ring-shaped interstice between the container wall and the pipe. The inlet and the outlet are disposed in such a manner that liquid introduced into the separation container flows downward along the container wall in a cyclone-like movement and then flows upward through the pipe to the outlet within the liquid that flows downward in cyclone manner. Solid particles separated as the result of the cyclone effect sink downward along the container wall into a dirt settling space provided at the lower container end.

By means of the present invention, a dirt separator of the stated type is to be improved in such a manner that it is optimal with regard to degree of efficiency and pressure loss, wherein at the same time, the most compact and cost-advantageous construction possible is supposed to be achieved.

### SUMMARY OF THE INVENTION

The essence of the invention consists of the following: A dirt separator comprises a vessel having a separation container having a lateral container wall, a container bottom, and a container axis, which container has an inlet and an outlet as well as an interior, and having a particle separation chamber, which is disposed at the outlet of the separation container and stands in a fluid connection with the separation container, an inlet for supply of liquid into the separation container and an outlet for discharge of the liquid from the particle separation chamber, wherein the dirt separator is configured in such a manner that liquid introduced into the separation container flows downward along the container wall in a cyclone-like movement and then flows upward to the particle separation chamber within the liquid that flows downward in cyclone manner, and wherein the dirt separator comprises at least one particle separator that is disposed in the particle separation chamber.

Placement of the separation container and the particle separation chamber in a vessel as well as of at least one particle separator in the particle separation chamber allows a particularly compact construction of the dirt separator, with particularly efficient particle separation and simultaneous minimization of pressure losses. This placement of the particle separator allows efficient guidance of the resulting cyclone in the separation container.

In particular, the particle separator is disposed outside of the separation container in the particle separation chamber. In this regard, the particle separator may be disposed in such a manner that it does not project into the separation container. The length of the part of the particle separator that is disposed in the separation chamber is therefore particularly smaller than the height of the particle separation chamber from the outlet of the separation container to the opening in the lid of the particle separation chamber. In particular, the particle separator is disposed entirely within the particle separation chamber. This placement of the particle separator allows efficient guidance of the resulting cyclone in the separation container without disruption, thereby making it possible for the cyclone to develop its complete effect, as compared with placement of the particle separator in the separation container, which could cause the cyclone to collapse.

In a further embodiment of the dirt separator, the at least one particle separator is a filter. The filter is particularly disposed in the particle separation chamber, in such a manner that the liquid that flows out of the outlet of the separation container during operation can flow through the filter. In this regard, the filter is preferably disposed in such a manner that the entire liquid that flows out of the outlet of the separation container during operation can flow through the filter.

Use of a filter as a particle separator allows very efficient removal of the residual particles that were not separated from the stream of liquid to be purified in the separation container.

In particular, the filter is disposed outside of the separation container in the particle separation chamber. The filter may be disposed entirely in the particle separation chamber.

The filter is preferably disposed in such a manner that the entire stream of liquid is passed through the filter during operation before the filtered liquid leaves the particle separation chamber, after fine particles have been removed.

In particular, the filter can be either cleaned or replaced by removing it, or it can be cleaned by means of back-flushing. In the case of back-flushing, the flushed-out particles can escape from the circuit by way of an opening, particularly by way of a valve, in the bottom of the separation container, and thereby can be separated from the system.

In another embodiment variant of the dirt separator, the at least one particle separator is a magnet. The magnet is particularly disposed in the particle separation chamber in such a manner that during operation, magnetic particles entrained in the liquid can be removed, at least in part, on the magnet before the liquid leaves the particle separation chamber or passes through the filter.

Use of a magnet as a particle separator allows very efficient removal, from the stream of liquid to be cleaned, of the magnetic residual particles that were not separated in the separation container.

In particular, the magnet is disposed outside of the separation container in the particle separation chamber. In this regard, the magnet may be disposed in such a manner that it does not project into the separation container. The length of the magnet part that is disposed in the separation chamber is therefore particularly smaller than the height of the particle separation chamber from the outlet of the separation container to the opening in the lid of the particle separation chamber.

In particular, the particle chamber may contain either only one (or more) magnets or one (or more) magnets in combination with one (or more) filters. A combination proves to be particularly advantageous for separation of the microparticles that were not separated in the separation container. In particular, the magnet captures magnetic particles before these reach the filter, thereby achieving a clearly longer useful lifetime of the filter.

In particular, the magnet may be removable from the outside, for example through an opening in the lid or in the wall of the particle separation chamber, without having to disassemble the dirt separator.

In another variant of the dirt separator, at least one drain valve is inserted into the container bottom, which valve is disposed in the container bottom non-centrally relative to the container axis and is connected with the interior of the separation container. In particular, a drain valve is used in the container bottom.

This non-central drain valve allows removal of the separated particles from the dirt separator even if the container axis and thereby the drain valve is not disposed vertically relative to plumb. This embodiment makes it possible to use the dirt separator horizontally or in any other position that deviates from plumb, in that the non-centrally disposed drain valve is disposed at the lowest possible point, where the particles collect in the separation container due to the force of gravity. This embodiment therefore proves to be particularly flexible when using the dirt separator.

In an alternative embodiment of the dirt separator, the container bottom of the separation container is formed by a domed bottom and at least one drain valve is inserted in the container bottom, which valve is disposed non-centrally relative to the container axis in the container bottom, and is connected with the interior of the separation container. The domed bottom may particularly be rotated about the container axis relative to the separation container.

A domed bottom has the advantage of a light design, which facilitates handling of the separation container during installation.

In another embodiment of the dirt separator, the container bottom of the separation container may be formed by a domed bottom having a non-central dome, which dome has its peak non-centrally relative to the container axis, and the drain valve is connected with the interior of the separation container at the peak of the domed bottom. In particular, the domed bottom may be rotated about the container axis relative to the separation container. The domed bottom is then connected with the separation container so as to rotate, using a coupling, for example.

Use of such a domed bottom with a non-central dome has the advantage of optimally adapting the position of the drain valve, particularly at the lowest possible point of the dirt separator, if the dirt separator is not disposed vertically.

In an additional embodiment of the dirt separator, the container bottom of the separation container is formed by a bottom plate, by means of which the drain valve is connected with the interior of the separation container non-centrally relative to the container axis, and, if applicable can be rotated about the container axis relative to the separation container. The bottom plate is connected with the separation container so as to rotate, for example using a coupling.

This embodiment allows very simple adaptation of the dirt separator to the requirements of use, as well as a very compact construction of the dirt separator.

In another alternative embodiment of the dirt separator, the container bottom of the separation container is formed by a bottom plate that has multiple closable openings spaced apart at an angle from one another and arranged non-centrally relative to the container axis, and the drain valve is connected with the interior of the separation container by means of one of the openings.

This embodiment allows a particularly simple configuration of the dirt separator.

In another alternative embodiment of the dirt separator, the particle separation chamber comprises a lid that is removable.

This embodiment allows access to the filter for easy removal of the particle separator, particularly of the filter, or also of the magnet, for the purpose of cleaning or replacement.

In another embodiment, the separation container has a preferably slow-flow dirt settling chamber. This facilitates sedimentation of the solids particles.

In an additional embodiment, an intermediate bottom having at least one peripheral opening is disposed in the separation container above the slow-flow dirt settling chamber. In this embodiment variant, the dirt settles on the intermediate bottom and then gets into the settling chamber underneath through the peripheral opening or openings, from where it then can be removed by means of a drain valve, for example.

The inlet and the outlet may be disposed at diametrically opposite sides of the separation container, with reference to the container axis, or also at an angle that deviates from 180° relative to the container axis, so that inlet and outlet are not disposed on diametrically opposite sides of the separation container with reference to the container axis. For example, the angle can amount to 90° or almost 90°.

The diametrically opposite placement of the inlet and of the outlet can facilitate installation of the dirt separator in a line for liquid, depending on the installation requirements.

An angle relative to the container axis between the inlet and the outlet can, however, be advantageous as compared with a diametrically opposite placement. This angle may have any desired value; in particular, inlet and outlet can be disposed at a right angle to the container axis, for example. An angle between inlet and outlet that deviates from 180° allows very simple deflection of the stream of liquid in the circuit, if this requirement exists, for example from a pipeline that runs vertically to a pipeline that runs horizontally, without the use of an additional pipe elbow.

Furthermore, in another embodiment, flow deflection means may be disposed in the separation container, which means deflect the liquid that flows in through the inlet into the separation container along the side of the container wall and at a slant downward.

An intensive cyclone-like flow of liquid is achieved by means of the use of the separate flow deflection means, on the one hand, and on the other hand, the pressure loss in the dirt separator is minimized. Once again, more efficient separation of solid particles is achieved by means of the improved cyclone-like flow of liquid.

It is practical if the flow deflection means have an outlet channel that connects a region of the interior of the separation container that is close to the axis with the outlet. This characteristic improves guidance of the out-flowing liquid.

Furthermore, it is practical if the flow deflection means, together with the container wall, form a flow channel that runs in a spiral away from the inlet, downward at a slant. This characteristic improves guidance of the in-flowing liquid.

It is advantageous if the flow deflection means have a bypass channel through which part of the liquid can flow directly from the inlet to the outlet. The pressure loss in the dirt separator according to the invention may be reduced even further by means of this bypass channel, without the separation effect decreasing to the same extent.

In a practical embodiment variant, the flow deflection means have a discharge pipe that is essentially coaxial to the container axis of the separation container and communicates with the particle separation chamber. The presence of such a discharge pipe is particularly advantageous in the case of relatively long or tall separation containers, because the formation of an efficient cyclone-like flow is promoted in this way.

It is advantageous if the inside diameter of the separation container is 1.4 to 3.2, preferably 1.8 to 2.6 times as great as the clear width of the inlet. In this regard, the inside diameter d_{B} of the separation container is measured in the region below the insert part or the discharge pipe. Furthermore it is advantageous if the inside height of the separation container, measured from the intermediate bottom, or, in the absence of the latter, from the container bottom to the uppermost level of the inside cross-section of the inlet, is 2 to 6, preferably 3 to 4.5 times as great as the clear width of the inlet. In this regard, the inside height of the separation container is measured from the container bottom in the absence of an intermediate bottom, or otherwise from the intermediate bottom, up to the uppermost level of the inside cross-section of the inlet. Furthermore, it is advantageous if the distance between an intermediate bottom of the separation container, or, if no intermediate bottom is present, between the container bottom, on the one hand, and the flow deflection means, i.e. their inlet opening for out-flowing liquid, on the other hand, is at least as great as ⅔ of the clear width of the inlet. With these dimension relationships of the dirt separator, formation of a particularly effective cyclone-like flow in the separation container and thereby a maximal separation effect are achieved.

Dirt is, for example, sludge to be separated. The sludge may comprise magnetic particles in form of magnetite or other magnetic substances.

The variants and characteristics mentioned and described here may also be implemented in a combination of two or more variants or characteristics with one another, and these combinations are also covered by the present invention, unless such combinations are mutually inconsistent.

### BRIEF DESCRIPTION OF THE DRAWINGS

In the following, the dirt separator according to the invention will be described in greater detail using exemplary embodiments, making reference to the attached drawings. These show:

FIG. 1—a cross-sectional view from above of a first exemplary embodiment of the dirt separator according to the invention;

FIG. 2—a longitudinal or vertical section of the dirt separator along the line II-II of FIG. 1;

FIG. 3—a partially cut-open view of the dirt separator according to the invention;

FIG. 4—a side view of the dirt separator according to the invention;

FIG. 5—a further side view of the dirt separator according to the invention;

FIG. 6—a longitudinal or vertical section of a further alternative of the dirt separator according to the invention;

FIG. 7—a top view of a further embodiment of the dirt separator according to the invention;

FIG. 8—a cross-sectional view from above of the embodiment of the dirt separator according to the invention according to FIG. 7;

FIG. 9—a side view of a further embodiment of the dirt separator according to the invention;

FIG. 10—a longitudinal or vertical section of an additional embodiment of the dirt separator according to the invention;

FIG. 11—a longitudinal or vertical section of an additional embodiment of the dirt separator according to the invention;

FIGS. 12-16—five variants of an intermediate bottom of the dirt separator.

### DETAILED DESCRIPTION OF THE INVENTION

The following statement applies for the description below: If reference symbols are indicated in a figure for the purpose of clarity of the drawing, but these symbols are not mentioned in the directly related description part, then the preceding or subsequent description parts should be referred to for an explanation. Vice versa, reference symbols that are less relevant for an immediate understanding of the drawing are not entered in all the figures, in order to avoid possible overload. In this regard, reference is made to the remaining figures, in each instance. The relative information “at the top,” “at the bottom,” “on the side,” etc. relates to the typical installation position of the dirt separator according to the invention in practical use, as shown in the figures.

Dirt is understood to be solid particles carried along, for example suspended, in a stream of liquid. Accordingly, a dirt separator in the sense of the invention is understood to be an apparatus for separating solid particles from a stream of liquid. In the following, only the shorter term of dirt separator will be used.

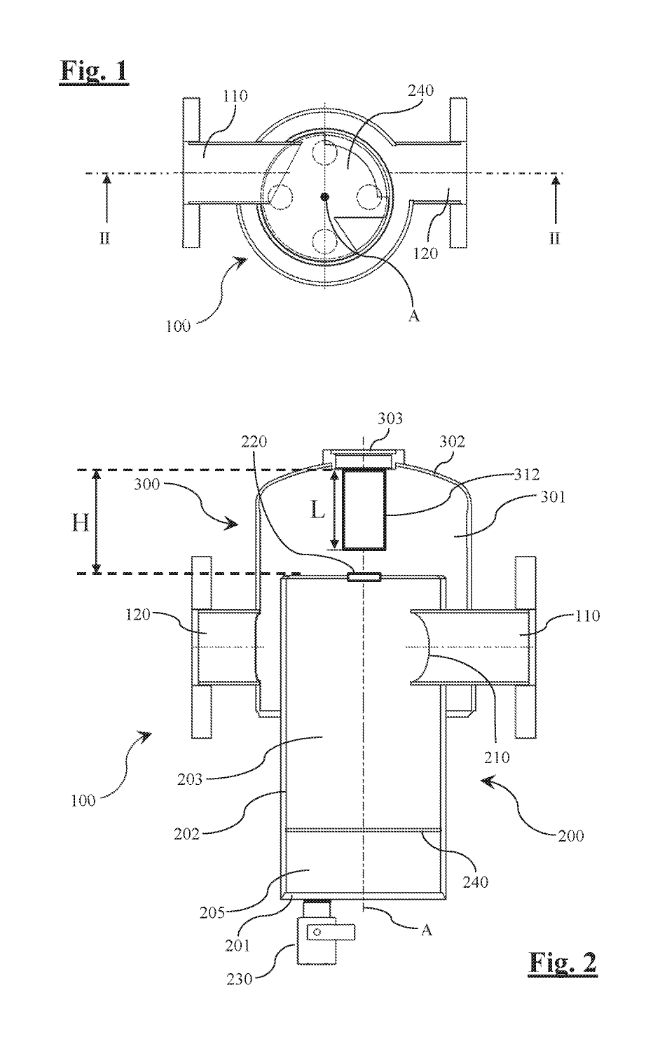

The embodiment of a dirt separator according to the invention shown in FIGS. 1-3 has a vessel 100 that has an inlet 110 and an outlet 120. Furthermore, the dirt separator has a pot-shaped separation container 200 having a container bottom 201, a container side wall 202, and a container axis A. The separation container 200 is configured essentially in cylindrical shape over its height. A drain valve 230 is inserted into the container bottom 201, which valve is disposed non-centrally relative to the container axis A.

The vessel 100 furthermore comprises a particle separation chamber 300, which has an interior 301 for accommodating a particle separator 310 and a vessel lid 302. In this embodiment, there is a magnet 312 in the particle separation chamber for removal of magnetic particles that were not removed in the separation container 200 by means of the cyclone-like movement of the liquid and were entrained into the particle separation chamber 300. The magnet 312 is removable from the outside through an opening 303 having a thread, in the lid 302 of the particle separation chamber 300 or in the wall of the particle separation chamber 300.

The magnet has the shape of a rod, for example, as is evident from the figure.

The magnet is disposed in such a manner that it does not project into the separation container, but rather is situated outside of the separation container in the particle separation chamber. As can be seen in FIG. 2, the length L of the magnet part that is disposed in the separation chamber is less than the height H of the particle separation chamber from the outlet 220 of the separation container 200 to the opening 303 in the vessel lid 302 of the particle separation chamber 300. Fundamentally, however, the magnet could be disposed in such a manner that it projects out of the opening 303 in the vessel lid 302 of the particle separation chamber 300.

In its uppermost region, below the—if applicable removable—vessel lid 302, the dirt separator has a connector-shaped inlet 110 and an also connector-shaped outlet 120. The inlet 110 and the outlet 120 are disposed on diametrically opposite sides of the dirt separator with reference to the container axis A and oriented coaxially relative to one another.

In the present exemplary embodiment, the container bottom 201 of the separation container 200 is formed by a bottom plate, which bottom plate has four closable bores 204 spaced apart from one another by an angle of 90°, non-centrally relative to the container axis. The drain valve 230 is connected with the interior 203 of the separation container by means of one of the bores 204, while the three other bores are closed off.

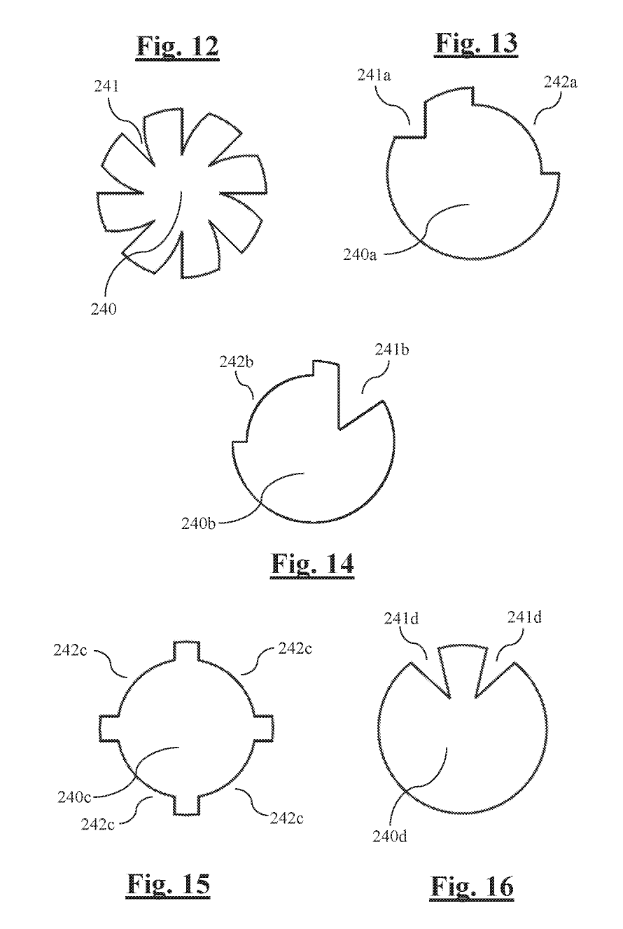

In the lower region of the separation container 200, there is a slow-flow dirt settling chamber above the container bottom 201, which chamber is delimited toward the top by a plate-shaped intermediate bottom 240, which is perforated on its periphery by multiple openings 241 (see also FIGS. 12 to 16 for further examples of insertable intermediate bottoms).

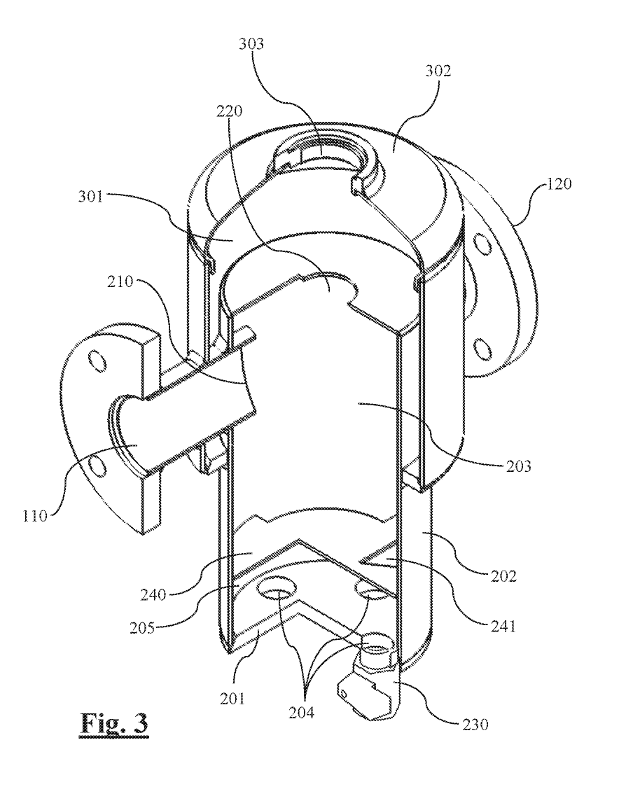

In FIG. 3, it can be seen that the vessel lid 302 of the particle separation chamber is removable. This figure shows a dirt separator without a particle separator. The particle separator may, for example in the case of a filter 311, be disposed in the particle separation chamber by means of removal of the lid 302, or, in the case of a magnet 312, may alternatively be introduced through the opening 303. Furthermore, in this figure the perspective arrangement of the individual components of a variant of the dirt separator can be seen.

In practical use, the dirt separator is installed in a line that conducts liquid. In this regard, this may typically be a household water line. The liquid gets into the dirt separator through the inlet 110 and into the separation container 200 through the inlet opening 210. Away from the inlet 210, the liquid is guided along the container wall 202, at a downward slant, into the container interior 203, wherein a cyclone-like flow movement occurs in the vicinity around the periphery of the separation container 200.

By means of the cyclone effect, the solid particles entrained in the liquid are primarily separated in the vicinity of the container wall 202 and settle on the intermediate bottom 240. The liquid then flows upward to the particle separation chamber 300 within the liquid that flows downward in cyclone manner, and through the outlet 220 of the separation container 200 continues into the particle separation chamber 300.

A slow-flow dirt settling chamber 205 is situated between the bottom 201 of the separation container 200 and the intermediate bottom 240. The solid particles that have sedimented onto the intermediate bottom 240 are flushed into the dirt settling chamber 205 by the stream of liquid, through the peripheral openings 241 of the intermediate bottom 240. The settled dirt can be conducted out of the dirt settling chamber 205 through the drain valve 230.

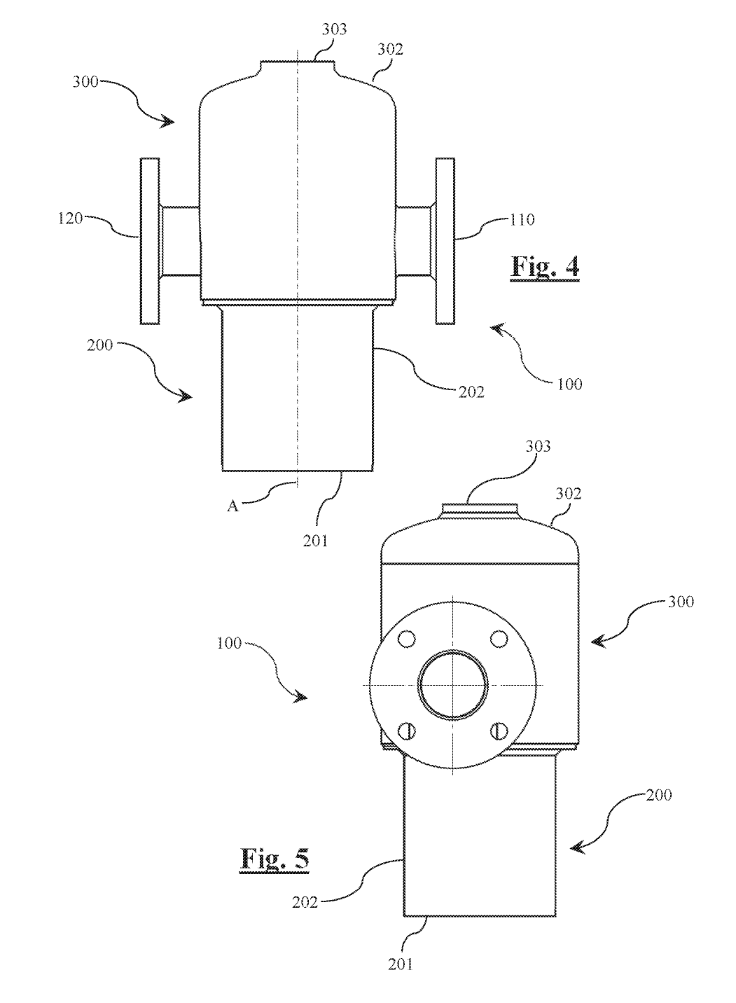

In FIGS. 4 and 5, two side views of the dirt separator according to the invention are shown.

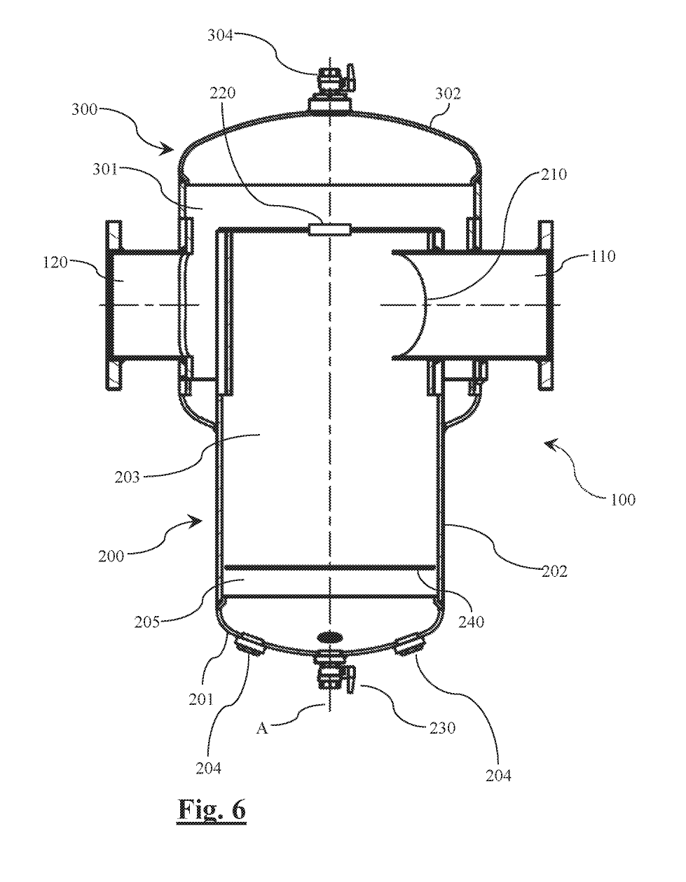

FIG. 6 shows a further embodiment of the dirt separator according to the invention without a particle separator, in which embodiment the bottom of the separation container 200 is formed by a domed bottom 201, which domed bottom 201 has closable bores 204 disposed at an angle relative to one another, non-centrally relative to the container axis A. The drain valve 230 is connected with the interior 203 of the separation container by means of one of the bores 204, while the three other bores are closed off.

The domed bottom may also have its peak disposed non-centrally relative to the container axis, and the drain valve 230 may be affixed at this peak. In this case, one bore 204 in the domed bottom 201 is sufficient, and the domed bottom 201 may be connected with the side wall 202 of the separation container 200, using a coupling, in such a manner that the domed bottom can be rotated. Furthermore, the embodiment in FIG. 6 has a valve that is connected with the particle separation chamber.

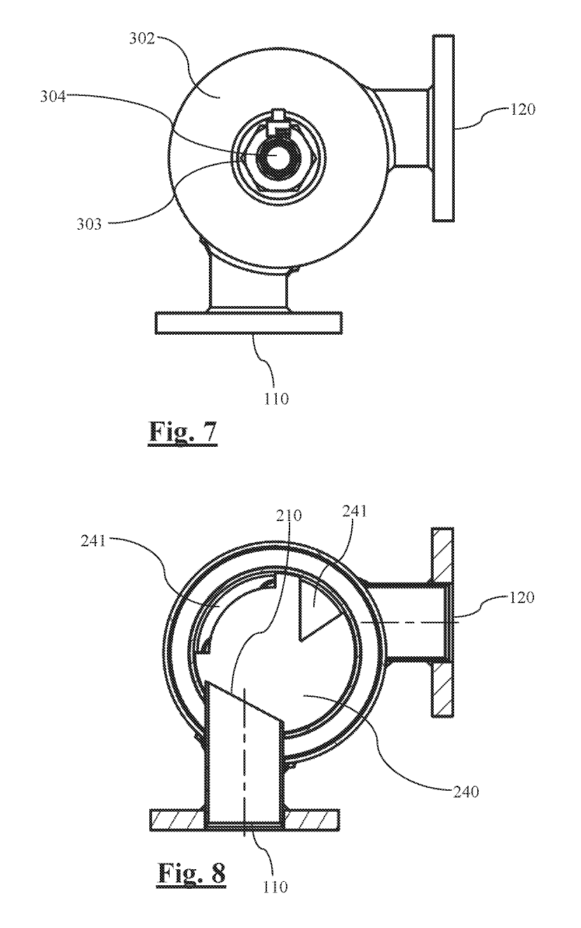

FIGS. 7 and 8 show a further embodiment of the dirt separator according to the invention, in which inlet 110 and outlet 120 of the dirt separator are disposed not diametrically opposite one another, but rather at an angle of 90° relative to the container axis. This special embodiment allows very easy deflection of the liquid stream in the circuit, for example from a pipeline that runs vertically and would be connected with the inlet 110 of the dirt separator, to a pipeline that runs horizontally and would be connected with the outlet 120 of the dirt separator, without the use of an additional pipe elbow.

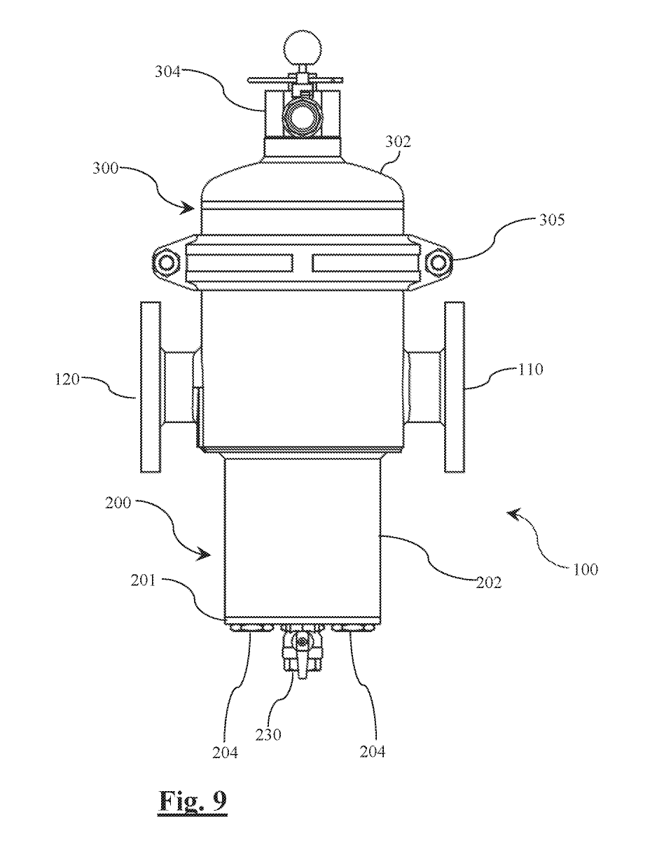

Furthermore, FIG. 9 shows an embodiment in which the vessel lid 302 is removable and is connected with the wall of the particle separation chamber 300 using a clamp 305.

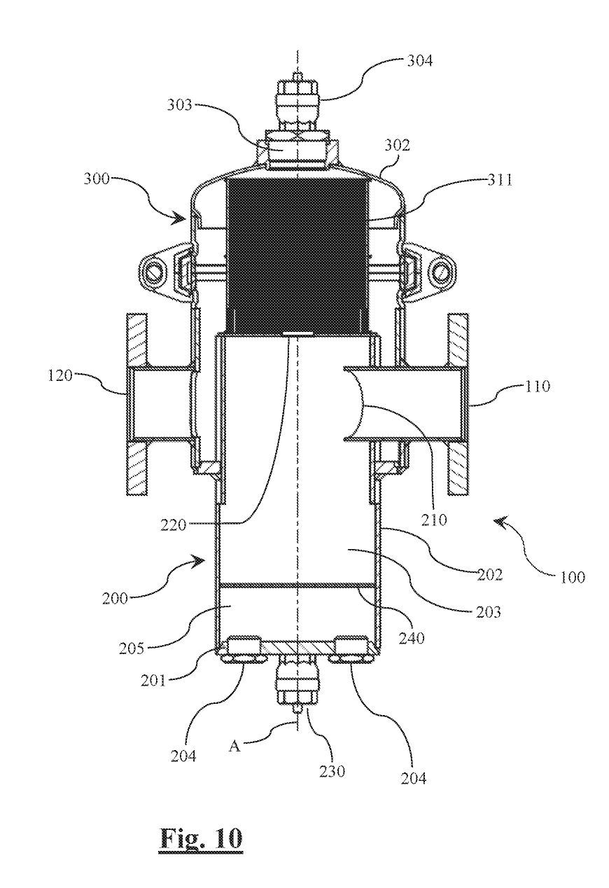

FIG. 10 shows an exemplary embodiment of the dirt separator according to the invention, in which a filter 311 is disposed in the particle separation chamber 300. In this embodiment, the filter has a cylindrical shape and is situated in the stream of liquid of the dirt separator. The filter 311 is disposed in such a manner that the entire stream of liquid is passed through the filter before the filtered liquid leaves the particle separation chamber, with fine particles removed.

The filter may also have different shapes, with the following examples being named: a cylindrical shape, a flat shape, which lies directly on the outlet 220, a domed shape above the outlet 220, or an inner lining of the particle separation chamber.

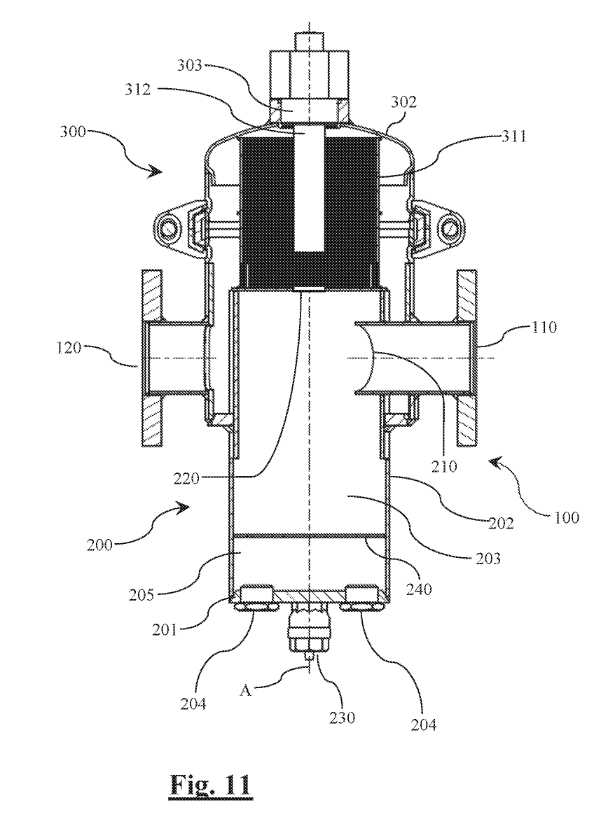

FIG. 11 shows an additional embodiment, in which both a filter 311 and also a magnet 312 are disposed in the particle separation chamber 300. The filter 311 has a cylindrical shape in this variant, as well, and surrounds the magnet 312, so that the liquid that exits from the outlet 220 of the separation container flows past the magnet, thereby causing the magnetic particles to be deposited on the magnet, and the liquid subsequently passes through the filter, in which the residual particles, which are not magnetic, for the most part, are captured. Here, too, the filter 311 is disposed in such a manner that the entire stream of liquid is passed through the filter before the filtered liquid leaves the particle separation chamber, with fine particles removed.

Because magnetic particles have already been captured by the magnet, for the most part, in the variant shown in FIG. 11, the useful lifetime until the filter has to be cleaned or actually replaced is clearly increased.

The intermediate bottom on which the solid particles settle may have different configurations. FIGS. 12-16 show four embodiments that differ in shape, number and distribution of peripheral openings or perforations. In the case of the intermediate bottom 240 according to FIG. 12, eight approximately wedge-shaped openings 241 are uniformly distributed over the circumference of the intermediate bottom 240. In the case of the intermediate bottom 240a of FIG. 13, a wedge-shaped opening 241a having a right angle and an arc-shaped opening 242a are disposed next to one another. In the case of the intermediate bottom 240b of FIG. 14, a wedge-shaped opening 241b having an acute angle and an arc-shaped opening 242b are disposed next to one another. In the case of the intermediate bottom 240c of FIG. 15, four arc-shaped openings 242c are disposed uniformly distributed over the circumference. In the case of the intermediate bottom 240d of FIG. 16, two wedge-shaped openings 241d that lie next to one another are provided. The number and shape of the openings may vary, wherein arrangements having a non-symmetrical distribution of the openings are more advantageous, because in this way, a cyclone flow is prevented in the space below the intermediate bottom.

An intermediate bottom is not necessary in every case. For example, the intermediate bottom 240 may also be eliminated in the exemplary embodiments of the dirt separator according to the invention shown in FIGS. 1-3.

The invention was explained above using exemplary embodiments, but is not supposed to be restricted to these exemplary embodiments. Instead, for a person skilled in the art, numerous modifications are conceivable without deviating from the teaching of the invention. The scope of protection is therefore defined by the following claims.

1. A dirt separator comprising a vessel having a separation container having a lateral container wall, a container bottom, and a container axis, which container has an inlet and an outlet as well as an interior, and having a particle separation chamber, which is disposed at the outlet of the separation container and stands in a fluid connection with the separation container, an inlet for supply of liquid into the vessel, and an outlet for discharge of the liquid out of the vessel, wherein the dirt separator is configured in such a manner that liquid introduced into the separation container flows downward along the container wall in a cyclone-like movement, and then flows upward to the particle separation chamber within the liquid that flows downward in cyclone-like manner, and wherein the dirt separator comprises at least one particle separator, which is disposed in the particle separation chamber.

2. The dirt separator according to claim 1, wherein the particle separator is disposed outside of the separation container.

3. The dirt separator according to claim 1, wherein the at least one particle separator is a filter, which is disposed in the particle separation chamber in such a manner that the liquid that flows out of the outlet of the separation container during operation can flow through the filter.

4. The dirt separator according to claim 3, wherein the at least one particle separator is a magnet, which is disposed in the particle separation chamber in such a manner that during operation, magnetic particles entrained in the liquid can be removed, at least in part, by the magnet before the liquid leaves the particle separation chamber or passes through the filter.

5. The dirt separator according to claim 1, wherein at least one drain valve is inserted into the container bottom, which valve is disposed in the container bottom non-centrally relative to the container axis and is connected with the interior of the separation container.

6. The dirt separator according to claim 5, wherein the container bottom of the separation container is formed by a domed bottom, and at least one drain valve is inserted in the container bottom, which valve is disposed in the container bottom non-centrally relative to the container axis and is connected with the interior of the separation container.

7. The dirt separator according to claim 6, wherein the domed bottom has a non-central dome, which domed bottom can be rotated about the container axis, particularly relative to the separation container, and which dome has its peak non-central to the container axis, and the drain valve is connected with the interior of the separation container at the peak of the domed bottom.

8. The dirt separator according to claim 5, wherein the container bottom of the separation container is formed by a bottom plate by means of which the drain valve is connected with the interior of the separation container and can be rotated relative to the separation container and about the container axis.

9. The dirt separator according to claim 5, wherein the container bottom of the separation container is formed by a bottom plate that has multiple closable openings, arranged non-centrally relative to the container axis, spaced apart from one another at an angle and the drain valve is connected with the interior of the separation container by means of one of the openings.

10. The dirt separator according to claim 1, wherein the particle separation chamber comprises a vessel lid that is removable.

11. The dirt separator according to claim 1, wherein the inlet and the outlet are disposed at an angle that deviates from 180° with reference to the container axis of the separation container.

12. The dirt separator according to claim 1, wherein the separation container has a preferably slow-flow dirt settling chamber in its lower region.

13. The dirt separator according to claim 12, wherein an intermediate bottom having at least one peripheral opening is disposed in the separation container, above the slow-flow dirt settling chamber.

14. The dirt separator according to claim 1, wherein flow deflection means are disposed in the separation container, which means deflect liquid flowing into the separation container through the inlet laterally along the container wall and downward at a slant.

15. The dirt separator according to claim 2, wherein the at least one particle separator is a filter, which is disposed in the particle separation chamber in such a manner that the liquid that flows out of the outlet of the separation container during operation can flow through the filter.

16. The dirt separator according to claim 2, wherein the particle separation chamber comprises a vessel lid that is removable.

17. The dirt separator according to claim 5, wherein the particle separation chamber comprises a vessel lid that is removable.

18. The dirt separator according to claim 2, wherein the inlet and the outlet are disposed at an angle that deviates from 180° with reference to the container axis of the separation container.

19. The dirt separator according to claim 2, wherein the separation container has a preferably slow-flow dirt settling chamber in its lower region.

20. The dirt separator according to claim 2, wherein flow deflection means are disposed in the separation container, which means deflect liquid flowing into the separation container through the inlet laterally along the container wall and downward at a slant.
